(19) United States
(12) Patent Application Publication
(10) Pub. No.: US 2015/0331575 A1
(43) Pub. Date: Nov. 19, 2015

(54) Method and System for Intent Centric Multi-Facet Content Presentation

(71) Applicant: YAHOO! INC., Sunnyvale, CA (US)

(72) Inventor: Bruno M. Fernandez-Ruiz, London (GB)

(21) Appl. No.: 14/343,966

(22) PCT Filed: Mar. 15, 2013
(86) PCT No.: PCT/CN2013/000298

§ 371 Date: Mar. 10, 2014

(51) Int. Cl. G06F 3/0481; G06T 19/00; G06T 19/20; G06F 3/0484

(52) U.S. Cl. CPC G06F 3/04815; G06F 3/04847; G06T 19/003; G06T 19/20; G06T 2200/24

(57) ABSTRACT

Methods, systems, and programming for presenting personalized content. In one example, a plurality pieces of content are retrieved in accordance with an estimated intent determined with respect to a user. A three-dimensional (3D) viewing construct is generated based on the plurality pieces of content. The 3D viewing construct is to be rendered in a user viewing interface comprising a plurality of content display panels. Each of the plurality of content display panels is used to display at least one of the plurality pieces of content. Navigation information from an interaction between the user and the user viewing interface is received. The 3D viewing construct is dynamically updated based on the navigation information.

### BACKGROUND

1. Technical Field

The present teaching relates to methods, systems, and programming for presenting personalized content.

2. Discussion of Technical Background

The advancement in the world of the Internet has made it possible to make a tremendous amount of information accessible to users located anywhere in the world. With the explosion of information, new issues have arisen such as how to select the most relevant content and organize and present the content in a visually effective yet pleasing manner. The issue is made even more challenging the size of viewing devices is continually shrinking.

FIG. 1 depicts a prior art example of rendering content in a two-dimensional (2D) user viewing interface. In this example, different pieces of content related to “wine” are rendered in the 2D user viewing interface 100 of a web browser or other applications. In the central display area 102 of the 2D user viewing interface 100, content such as, wine dictionary 106, winery locations 108, wine and hair 110, and pizza and wine pairing 112, is displayed. In the top display area 104, other wine-related content, such as wine spectator, is presented as well. In addition, advertisements related to wines, wineries, or restaurants may be displayed in the left display area 116. In this example, once the user clicks any content in the central display area 102, such as the winery locations 108, an extended display area 114 may expand on the same 2D plane to show the details of the winery locations 108. However, due to the limited display space on the user device, some pieces of content may not be fully presented in the 2D user viewing interface 100. For example, the user may have to scroll down the vertical scroll bar 118-1 in order to see the content at the bottom of the extended display area 114 and the left display area 116. Also, content in the right portion of the top display area 104 can only be seen by scrolling the horizontal scroll bar 118-2.

The problem of limited real estate space on a viewing device for presenting content is exacerbated for mobile device. User of the mobile device may have to keep scrolling the content page they are browsing or zoom in a specific area to magnify the corresponding content. It is nearly impossible to view different pieces of content at the same time on the screen. Flipping between different pieces of content is annoying and inefficient. Displaying advertisement that is relevant to the content being viewed is also made difficult due to size limitation. Therefore, there is a need to expand the limited display real estate on a viewing device so that different pieces of content can be effectively rendered on a user device in a visually pleasing manner to solve the above-mentioned problems.

### SUMMARY

The present teaching relates to methods, systems, and programming for presenting personalized content.

In one example, a method, implemented on at least one machine each of which has at least one processor, storage, and a communication platform connected to a network for providing content, is disclosed. A plurality pieces of content are retrieved in accordance with an estimated intent determined with respect to a user. A three-dimensional (3D) viewing construct is generated based on the plurality pieces of content. The 3D viewing construct is to be rendered in a user viewing interface comprising a plurality of content display panels. Each of the plurality of content display panels is used to display at least one of the plurality pieces of content. Navigation information from an interaction between the user and the user viewing interface is received. The 3D viewing construct is dynamically updated based on the navigation information.

In another example, a method, implemented on at least one machine each of which has at least one processor, storage, and a communication platform connected to a network for providing content, is disclosed. A 3D viewing construct comprising a plurality pieces of content retrieved in accordance with an estimated intent with respect to a user is received. One or more parameters related to a configuration of a user viewing interface are obtained. The 3D viewing construct is rendered in the user viewing interface in accordance with the one or more parameters related to the configuration of the user viewing interface. Navigation information is obtained based on an interaction between the user and the user viewing interface and transmitted. An updated 3D viewing construct is received. The updated 3D viewing construct is generated based on the navigation information with respect to the 3D viewing construct.

In still another example, a method, implemented on at least one machine each of which has at least one processor, storage, and a communication platform connected to a network for providing content, is disclosed. A 3D viewing construct comprising a plurality pieces of content retrieved in accordance with an estimated intent with respect to a user is received. One or more parameters related to a configuration of a user viewing interface are obtained. The 3D viewing construct is rendered in the user viewing interface in accordance with the one or more parameters related to the configuration of the user viewing interface. Navigation information is obtained based on an interaction between the user and the user viewing interface. The 3D viewing construct is re-rendered in the user viewing interface based on the navigation information.

In a different example, a system for providing content is disclosed. The system includes a personalized content retriever, a personalized viewing pager constructor, and a user intent estimator. The personalized content retriever is configured to retrieve a plurality pieces of content in accordance with an estimated intent determined with respect to a user. The personalized viewing pager constructor is configured to generate a 3D viewing construct based on the plurality pieces of content. The 3D viewing construct is to be rendered in a user viewing interface comprising a plurality of content display panels. Each of the plurality of content display panels is used to display at least one of the plurality pieces of content. The user intent estimator is configured to receive navigation information from an interaction between the user and the user viewing interface. The personalized viewing pager constructor is further configured to dynamically update the 3D viewing construct based on the navigation information.

In another example, a system for providing content is disclosed. The system includes a communication interface, a user interface rendering module, and a navigation module. The communication interface is configured to receive a 3D viewing construct comprising a plurality pieces of content retrieved in accordance with an estimated intent with respect to a user. The communication interface is also configured to obtain one or more parameters related to a configuration of a user viewing interface. The user interface rendering module is configured to render the 3D viewing construct in the user viewing interface in accordance with the one or more parameters related to the configuration of the user viewing interface. The navigation module is configured to obtain navigation information based on an interaction between the user and the user viewing interface. The communication interface is further configured to transmit the navigation information and receive an updated 3D viewing construct. The updated 3D viewing construct is generated based on the navigation information with respect to the 3D viewing construct,

In still another example, a system for providing content is disclosed. The system includes a communication interface, a user interface rendering module, and a navigation module. The communication interface is configured to receive a 3D viewing construct comprising a plurality pieces of content retrieved in accordance with an estimated intent with respect to a user. The communication interface is also configured to obtain one or more parameters related to a configuration of a user viewing interface. The user interface rendering module is configured to render the 3D viewing construct in the user viewing interface in accordance with the one or more parameters related to the configuration of the user viewing interface. The navigation module is configured to obtain navigation information based on an interaction between the user and the user viewing interface. The user interface rendering module is further configured to re-render the 3D viewing construct in the user viewing interface based on the navigation information.

Other concepts relate to software for providing content. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for providing content, wherein the information, when read by the machine, causes the machine to perform a series of steps. A plurality pieces of content are retrieved in accordance with an estimated intent determined with respect to a user. A three-dimensional (3D) viewing construct is generated based on the plurality pieces of content. The 3D viewing construct is to be rendered in a user viewing interface comprising a plurality of content display panels. Each of the plurality of content display panels is used to display at least one of the plurality pieces of content. Navigation information from an interaction between the user and the user viewing interface is received. The 3D viewing construct is dynamically updated based on the navigation information.

In another example, a machine readable and non-transitory medium having information recorded thereon for providing content, wherein the information, when read by the machine, causes the machine to perform a series of steps. A 3D viewing construct comprising a plurality pieces of content retrieved in accordance with an estimated intent with respect to a user is received. One or more parameters related to a configuration of a user viewing interface are obtained. The 3D viewing construct is rendered in the user viewing interface in accordance with the one or more parameters related to the configuration of the user viewing interface. Navigation information is obtained based on an interaction between the user and the user viewing interface and transmitted. An updated 3D viewing construct is received. The updated 3D viewing construct is generated based on the navigation information with respect to the 3D viewing construct.

In still another example, a machine readable and non-transitory medium having information recorded thereon for providing content, wherein the information, when read by the machine, causes the machine to perform a series of steps. A 3D viewing construct comprising a plurality pieces of content retrieved in accordance with an estimated intent with respect to a user is received. One or more parameters related to a configuration of a user viewing interface are obtained. The 3D viewing construct is rendered in the user viewing interface in accordance with the one or more parameters related to the configuration of the user viewing interface. Navigation information is obtained based on an interaction between the user and the user viewing interface. The 3D viewing construct is re-rendered in the user viewing interface based on the navigation information.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a prior art example of rendering content in a 2D user viewing interface;

FIG. 2 depicts an example of rendering a three-dimensional (3D) viewing construct in a user viewing interface, according to an embodiment of the present teaching;

FIG. 3 depicts another example of rendering a 3D viewing construct in a user viewing interface, according to an embodiment of the present teaching;

FIG. 4 depicts still another example of rendering a 3D viewing construct in a user viewing interface, according to an embodiment of the present teaching;

FIG. 5 depicts yet another example of rendering a 3D viewing construct in a user viewing interface, according to an embodiment of the present teaching;

FIG. 6 depicts an exemplary networked environment in which a 3D viewing construct is generated and rendered, according to an embodiment of the present teaching;

FIG. 7 depicts another exemplary networked environment in which a 3D viewing construct is generated and rendered, according to an embodiment of the present teaching;

FIG, 8 is an exemplary functional block diagram of a user device on which a 3D viewing construct is rendered, according to an embodiment of the present teaching;

FIG. 9 is a flowchart of an exemplary process for rendering a 3D viewing construct in a user viewing interface, according to an embodiment of the present teaching;

FIG. 10 is a flowchart of another exemplary process for rendering a 3D viewing construct in a user viewing interface, according to an embodiment of the present teaching;

FIG. 11 is an exemplary functional block diagram of 3D viewing construct engine for generating a 3D viewing construct, according to an embodiment of the present teaching;

FIG. 12 is an exemplary functional block diagram of a personalized viewing page constructor in the 3D viewing construct engine, according to an embodiment of the present teaching;

FIG. 13 is a flowchart of an exemplary process for generating a 3D viewing construct, according to an embodiment of the present teaching;

FIG. 14 is a flowchart of another exemplary process for generating a 3D viewing construct, according to an embodiment of the present teaching;

FIG. 15 depicts an example of rendering a 3D viewing construct in a superimposing structure on a user device, according to an embodiment of the present teaching;

FIG. 16 depicts another example of rendering a 3D viewing construct in a superimposing structure on a user device, according to an embodiment of the present teaching;

FIG. 17 is an exemplary functional block diagram of a user device on which a user interface rendering module and a navigation module reside, according to an embodiment of the present teaching; and

FIG. 18 is an exemplary functional block diagram of a general computer architecture on which the present teaching can be implemented.

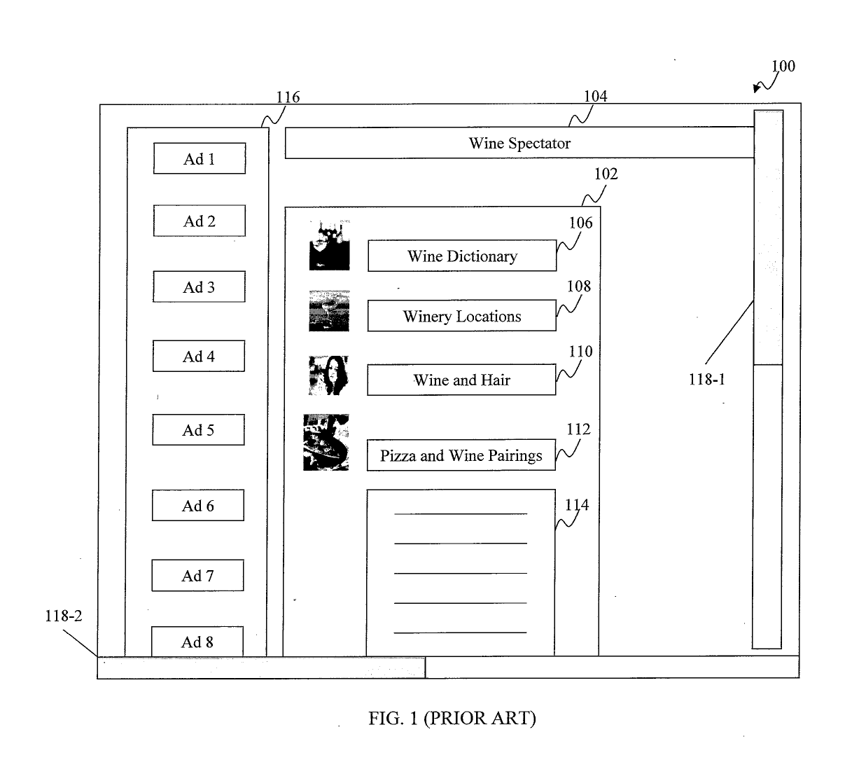

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of intent centric multi-facet content presentation. The method and system generate a viewing construct with multiple pieces of content retrieved based on a focus on interest with respect to a user, estimated either from the user's request or from the user's interaction with the displayed content. The method and system further look for content that serves that interest and then arrange the content in a multi-panel viewing interface in a manner that is both visually pleasing enough and can also incorporate more content given the limited real estate available on a display screen of the user device.

The method and system create an expanded virtual 3D display space that allows for continued personal interest exploration, dynamic intent-based content gathering, and intent centric multi-facet display. When a user clicks on a certain piece of content in the expanded space, e.g., an advertisement for a movie, a shift in the intent of the user may be recognized and some or the entire expanded space may now be devoted to a different intent and the content to be displayed may be reconstructed to be directed to the shifted new user intent. In this case, different pieces of content surround that new intent may be gathered and displayed. For example, the trailer of the interested movie may be displayed on the front panel (surface), a list of local movie theaters and schedules for that movie may be displayed on another surface, the cast of the movie may be displayed on still another surface, and local events in which the cast will appear may be displayed on yet another surface.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

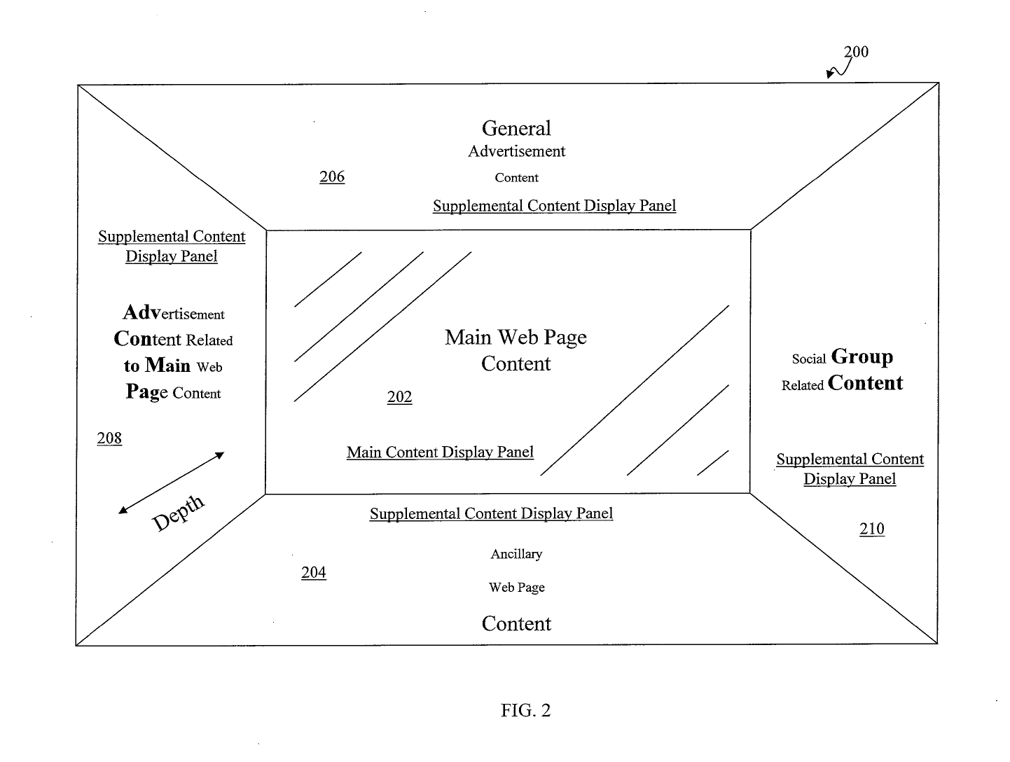

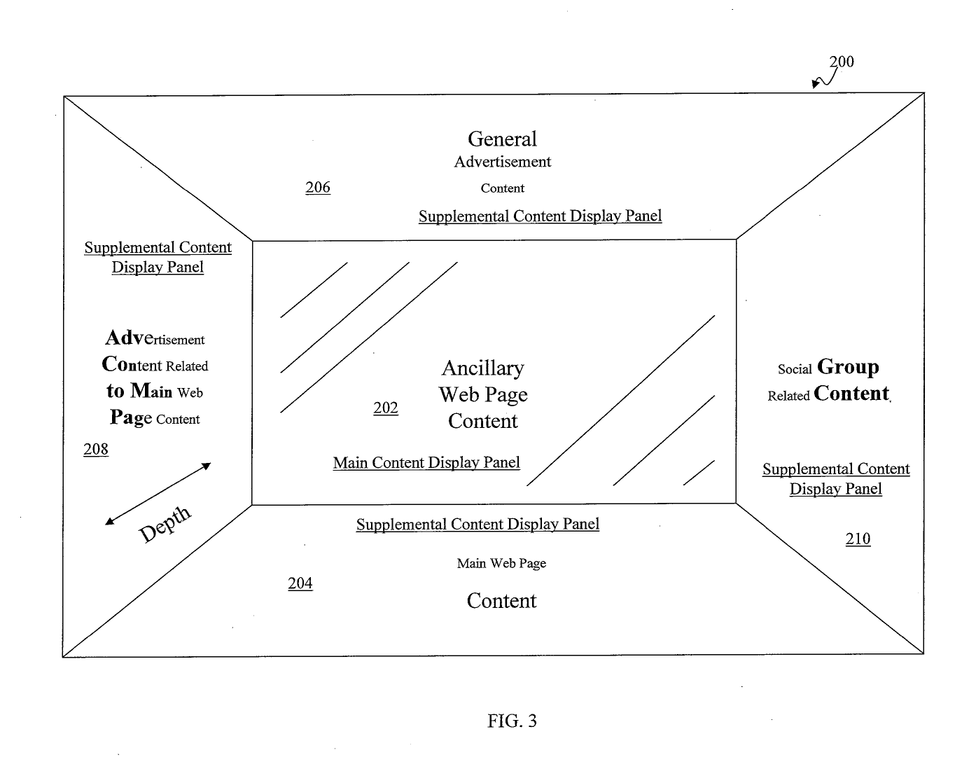

FIG. 2 depicts an example of rendering a three-dimensional (3D) viewing construct in a user viewing interface, according to an embodiment of the present teaching. The 3D viewing construct referred herein may be a data structure with a collection of content and/or links to content associated with meta data indicating which piece of content is designated to be displayed in which region of a user viewing interface. The content referred herein includes, but is not limited to, for example, text, audio, image, video or any combination thereof. The meta data may include parameters related to the configuration of the user viewing interface. For example, the parameter may include the 3D position and orientation of each piece of content to be rendered. Other parameters will be described further in detail.

As shown in FIG. 2, a collection of content are rendered in the user viewing interface 200 having multiple content display panels, each of which is used to display at least one piece of content. In this example, the user viewing interface 200 includes a main content display panel 202 for displaying main content (e.g., main web page content) and four supplemental content display panels 204, 206, 208, 210 for displaying supplemental content related to the main content. The user viewing interface 200 in this example is configured and rendered as a 3D pipe structure having a cross section surrounded by side walls. The cross section of the 3D pipe structure corresponds to the main content display panel 202 and the side walls of the 3D pipe structure correspond to the four supplemental content display panels 204, 206, 208, 210, respectively. The shape of the main content display panel 202 (i.e., cross section) is rendered as a rectangular, and each of the supplemental content display panels 204, 206, 208, 210 (i.e., side walls) is rendered to have a flat surface. In other examples, the shape of the cross section may be a circle, an ellipse, a square or any other shapes, and the side walls may have curved surfaces. The configuration of the 3D pipe structure may be further controlled by the configuration parameters, which is part of the 3D viewing construct, such as a depth factor indicating the depth of the 3D pipe structure in a direction perpendicular (Z direction) to the display screen (X-Y plane) and the layout and aspect ratio of the main content display panel 202 and each supplemental content display panel 204, 206, 208, 210. It is understood that the 3D arrangement of the 3D pipe structure may be reconfigured in real time in response to the user's interaction with the 3D pipe structure. In other words, the user viewing interface 200 may be dynamically re-rendered based on user interactions. For example, the user may change the depth of the 3D pipe structure by dragging the cross section or may change the size of a side wall using a double finger gesture on a touch screen.

In this example, the main content display panel 202 displays main web page content, and the supplemental content display panel 204 displays ancillary web page content, which, for example, provides context of the main content. In one example, the main content may be the latest news of 007 Sky Fall movie, and the ancillary web page content may be the IMDB page showing the cast and storyline of the movie. The supplemental content display panel 206 displays general advertisement related to, for example, the topic of the main content. In the example of 007 Sky Fall movie, the general advertisement may be any advertisements, promotions, or campaign information related to movie theaters or movies, which is not necessarily directed to the specific 007 Sky Fall movie. The supplemental content display panel 208, instead, displays advertisement content related to the main web page content. For example, advertisements, promotions, or campaign information related to a movie theater nearby the user's current location and that is currently showing the 007 Sky Fall movie. The supplemental content display panel 210 in this example displays social group related content, i.e., social network information associated with the main content. For example, the social group related content may be a social group discussing the 007 Sky Fall movie that the user may want to join in. It is understood that the particular types of content rendered on each supplemental content display panel 204, 206, 208, 210 is not limited by the exemplary embodiment and may be any content related to the main content, such as but not limited to, contextual content, advertisement, and social network information associated with the main content and/or information related to the user.

As shown in FIG. 2, the main content displayed on the main content display panel 202 occupies the central area of the display screen with the best perspective compared with the supplemental content displayed on the surrounding supplemental content display panels 204, 206, 208, 210. Due to the nature of a 3D structure, content displayed on the supplemental content display panels 204, 206, 208, 210, e.g., side walls of the 3D pipe structure, may not have the same display quality as being displayed on a 2D structure. For example, the size of the text may seem to be distorted. However, as supplemental content is considered as less important to the user compared with the main content and may not be the focus of the user, the display quality of the supplemental content may be compromised in exchange for the maximized utilization of the limited display area. In other words, compared with the known solutions for example in FIG, 1, the 3D viewing construct is rendered in the user viewing interface in a manner that is both visually pleasing enough and can also incorporate more content given the limited real estate available on a display screen of the user device. Moreover, once an interaction between the user and the user viewing interface occurs, navigation information related to the interaction may be captured and used to update the 3D viewing construct to reflect the shift of focus of interest indicated by the user interaction. In other words, if the main content displayed on the main content display panel 202 does not really match the user's actual intent or if the user has changed her/his focus of interest, then the 3D viewing construct may be dynamically updated to replace the main content with other content that is estimated to be more relevant or attractive to the user. In this way, dynamically updated main content may be always displayed on the main content display panel 202.

FIG. 3 depicts another example of rendering a 3D viewing construct in a user viewing interface, according to an embodiment of the present teaching. Compared with the exemplary embodiment shown in FIG, 2, the user viewing interface 200 remains the same while the main content displayed on the main content display panel 202 has been changed to the ancillary web page content that was previously displayed on the supplemental content display panel 204 in FIG. 2. The update may be caused by an interaction between the user and the supplemental content display panel 204. For example, a user may find she/he is more interested in exploring the details of the cast of the 007 Sky Fall movie rather than reading the news shown on the main content display panel 202 and thus, click the link to the cast displayed on the supplemental content display panel 204. In response to the user interaction, i.e., clicking, the 3D viewing construct is updated by updating the main content to become the details of the cast and updating the supplemental content on the supplemental content display panel 204 to become the news of the movie. The supplemental content in other supplemental content display panel 206, 208, 210 may also be updated to reflect the update of the main content and/or the shift of the user intent and become content that is more related to the cast of the movie. In other words, once the main content of the 3D viewing construct is updated due to the change of user intent, supplemental content may also be updated based on the updated main content and/or the updated intent. By doing so, it is ensured that the estimated most desirable content is always displayed with the best visual effect and the supplemental content for the most desirable content is dynamically refreshed accordingly.

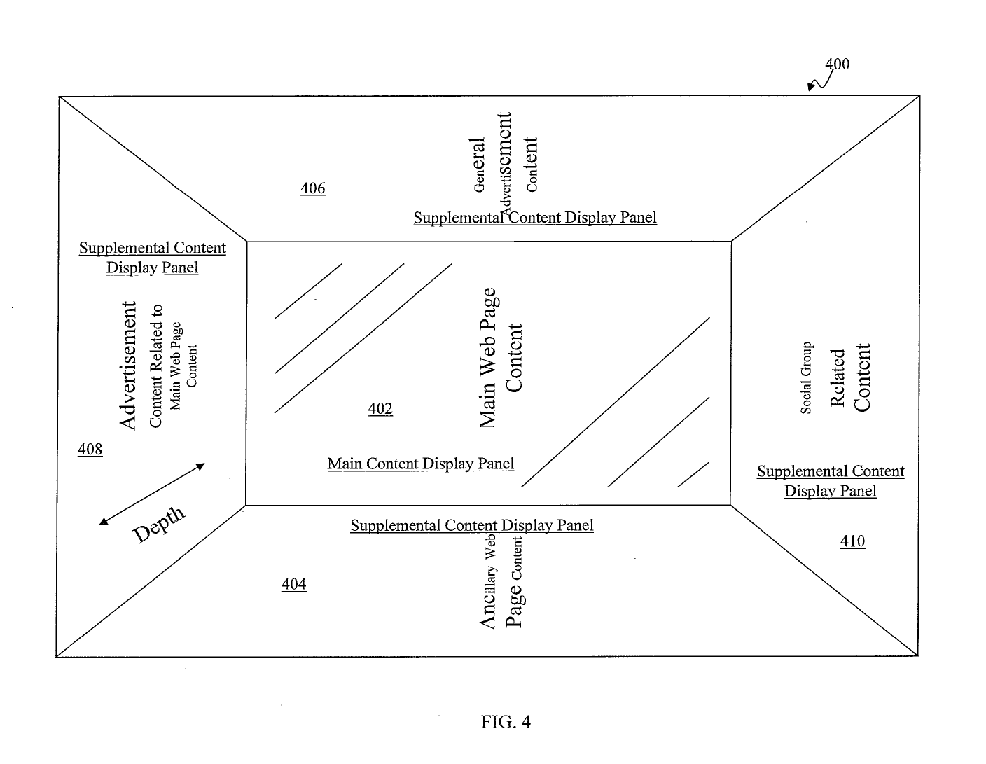

It is understood that the user interaction may not always cause the update of the 3D viewing construct, but instead, may just cause the re-rendering of the same 3D viewing construct in the user viewing interface with a different configuration. In the example shown in FIG. 4, the 3D viewing construct is the same as that in FIG. 2. In other words, the main and supplemental content remain the same. However, in this example, a user interaction, such as rotating the display of the user device, may cause the re-rendering of the same 3D viewing construct in an updated user viewing interface 400. In this example, the display layouts (e.g., direction of the content presentation) of the main content display panel 402 and each supplemental content display panel 404, 406, 408, 410 have been rotated 90 degrees, compared with the example in FIG. 2, as an response to the rotation of the display screen. That is, one of the configuration parameters, i.e., the display layout parameter, is changed in response to the user interaction, thereby causing the re-rendering of the 3D viewing construct.

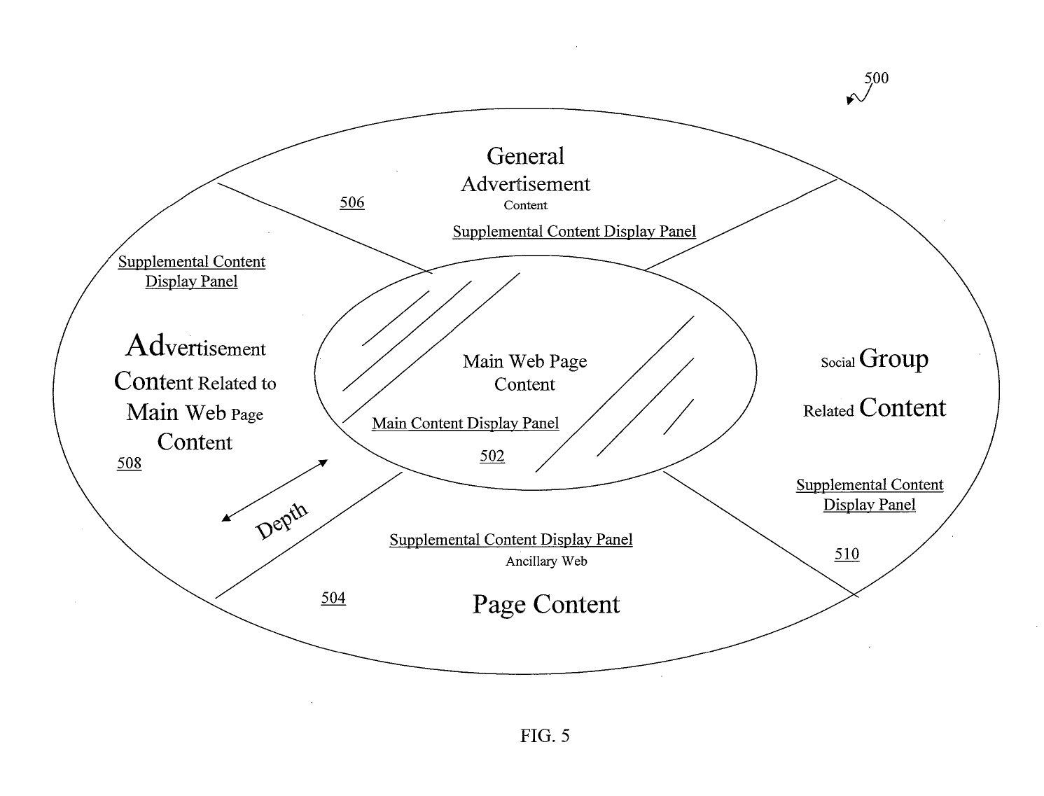

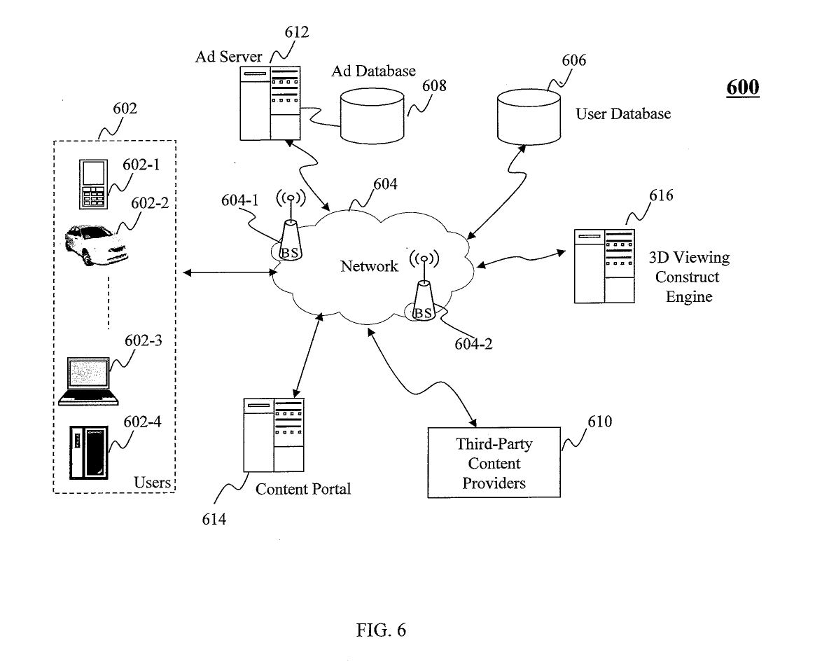

FIG. 5 depicts still another example of rendering a 3D viewing construct in a user viewing interface, according to an embodiment of the present teaching. In the examples with respect to FIGS. 2-4, the 3D viewing construct is rendered as a 3D pipe structure. It is understood that any other 3D structures may be used as possible configurations of the user viewing interface in which the 3D viewing construct is rendered. In FIG. 5, the 3D viewing construct is rendered in the user viewing interface 500 as a “wormhole” structure, which includes a center region corresponding to the main content display panel 502 and surrounding regions corresponding to the supplemental content display panels 504, 506, 508, 510. The center region of the wormhole structure may have an ellipse shape, and each surrounding region of the wormhole structure may have a curved surface. It is understood that any other 3D structures that may better utilize the limited 2D display real estate of a user device may be chosen as possible configurations of the user viewing configuration.

FIG. 6 depicts an exemplary networked environment in which a 3D viewing construct is generated and rendered, according to an embodiment of the present teaching. The network environment 600 includes users 602, a network 604, a user database 606, an advertisement database 608, third-party content providers 610, an advertisement server 612, a content portal 614, and a 3D viewing construct engine 616. The network 604 may be a single network or a combination of different networks. For example, the network 604 may be a local area network (LAN), a wide area network (WAN), a public network, a private network, a proprietary network, a Public Telephone Switched Network (PSTN), the Internet, a wireless network, a virtual network, or any combination thereof. The network 604 may also include various network access points, e.g., wired or wireless access points such as base stations or Internet exchange points 604-1, . . . , 604-2, through which a data source may connect to the network in order to transmit information via the network.

The content portal 614 may include, for example, search engines and social media websites that retrieve, select, and organize content from external and internal content sources and provide personalized content to the users 602 in response to their requests. The 3D viewing construct engine 616 in this example may be separated from the content portal 614 and acts as an independent service provider to provide 3D viewing construct to the users 602. 3D viewing constructs may be generated by the 3D viewing construct engine 616 based on user estimated intents and sent to the devices of the users 602 to be rendered in the user viewing interface. The 3D viewing construct engine 616 may further monitor the users' interactions with the user viewing interface and collect the navigation information from the interactions as a basis for dynamically updating the 3D viewing construct.

Users 602 may be of different types, i.e., users connected to the network 604 via different user devices such as a desktop computer 602-4, a laptop computer 602-3, a handheld device 602-1, or a built-in device in a motor vehicle 602-2. A user 602 may access to the 3D viewing construct engine 616 by sending a request to the 3D viewing construct engine 616 via the network 604 and receiving the 3D viewing construct from the 3D viewing construct engine 616 through the network 604. Information related to the users 602, such as user profile, activities and user-related content may be collected by the content portal 614 and/or the 3D viewing construct engine 616 through the user devices or obtained from an external user database 606. User-related information may be analyzed by the 3D viewing construct engine 616 to estimate the user's intents on content browsing, e.g., long-term and short-term user interests, in order to construct and update the 3D viewing construct.

Content sources, such as the advertisement server 612 in conjunction with the advertisement database 609 and third-party content providers 610, may actively or passively provide content to the 3D viewing construct engine 616 for selecting the main and supplemental content to be included in the 3D viewing construct. A content source may correspond to a web page host corresponding to an entity, whether an individual, a business, or an organization such as USPTO.gov, a content provider such as cnn.com and Yahoo.com, or a content feed source such as tweeter or blogs. For example, the 3D viewing construct engine 616 may fetch content, e.g., websites, through its crawler.

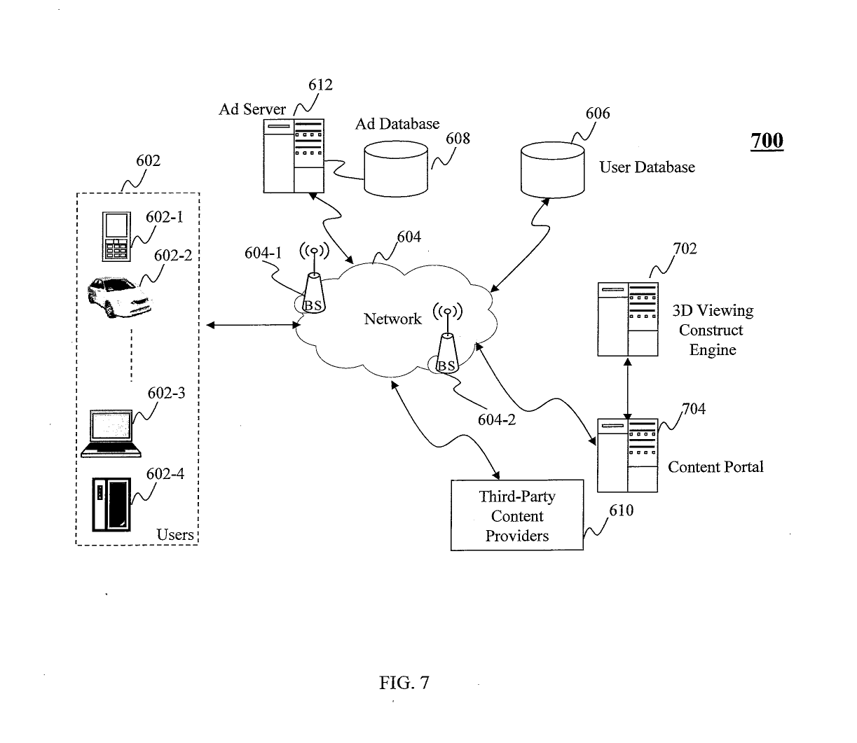

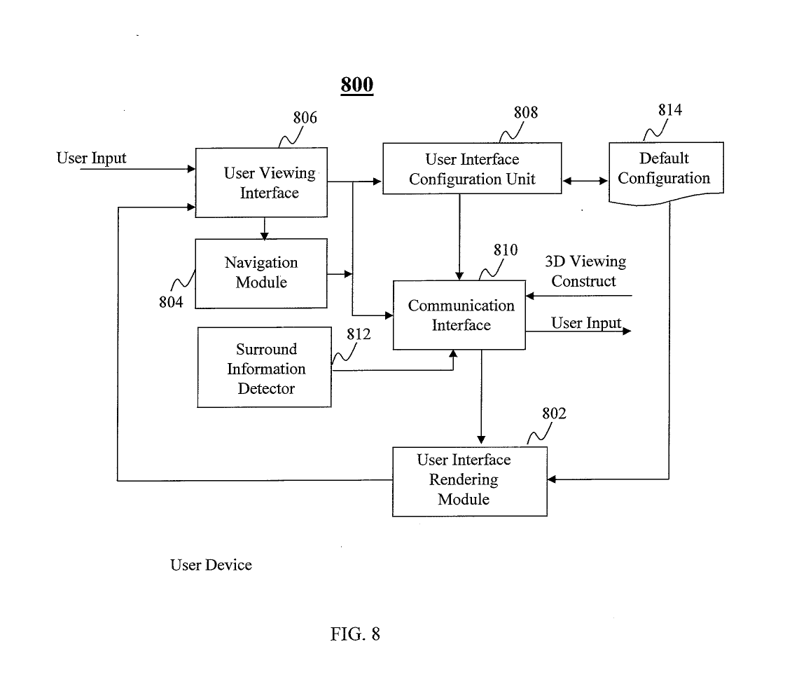

FIG. 7 presents a similarly network environment as what is shown in FIG. 6 except that the 3D viewing construct engine 702 now acts as a backend of the content portal 704. In this exemplary network environment 700, the users 602 do not directly interact with the 3D viewing construct engine 702. Instead, the request for content and other user input are received by the content portal 704, and the 3D viewing construct created and updated by the 3D viewing construct engine 702 is also delivered to the users 602 through the content portal 614.

FIG. 8 is an exemplary functional block diagram of a user device on which a 3D viewing construct is rendered, according to an embodiment of the present teaching. In this example, the user device 800 may include a user interface rendering module 802, a navigation module 804, a user viewing interface 806, a user interface configuration unit 808, a communication interface 810, and a surround information detector 812.

The user viewing interface 806 receives user input from the user and transmits different types of user input to the user interface configuration module 808 and navigation module 804, respectively. For example, the user input may include input regarding the configuration parameters of the user viewing interface 806 in which the 3D viewing construct is to the rendered. The input regarding the configuration parameters is processed by the user interface configuration module 808 to create and update a default configuration 814. The parameters that can be configured by the user include, but are not limited to, a dimensionality of the user viewing interface, a shape of the user viewing interface, a shape and/or a size of the main content display panel, a depth factor of the user viewing interface, construction parameters indicating relative spatial relationships of the plurality of content display panels of the user viewing interface, a number of supplemental content display panels and/or a shape and size of each of the supplemental content display panels, a relative position of the main content display panel, a relative position of each of the one or more supplemental content display panels, a layout of the main content display panel, a layout of each of the one or more supplemental content display panels, an aspect ratio of the main content display panel, and an aspect ratio of each of the one or more supplemental content display panels.

The user input may also include navigation information from the interaction between the user and the user viewing interface 806, such as cursor hovering, zooming, clicking, sliding, scrolling, taping, and pressing. The navigation information is extracted by the navigation module 804 from the user input and will be used for estimating an updated user intent in order to dynamically update the 3D viewing construct. As the content is rendered in a 3D space in which different content display panels may have different depths, the interaction with the user viewing construct may also occur in different planes. In addition to navigation in the traditional X-Y plane (the display screen), navigation along the Z-axis (direction perpendicular to the display screen) may also become possible. For example, on a touch screen, two finger ping and scroll gesture may rotate the user viewing interface along X-Z, Y-Z or X-Y planes. In another example, clicking, holding and moving the pointer may also rotate the user viewing interface along X-Z, Y-Z or X-Y planes.

The user input may further include information related to the user, such as demographics and user profile, which may be used to estimate user intents. The user input, including the configuration parameters and navigation information, is transmitted to a 3D viewing construct engine through the communication interface 810. In addition, surround information, for example, location, time, motion state, weather, direction, wireless signal strength, ambient-light intensity, mobile device type, and power state of the user devices, may be detected by the surround information detector 812 and also sent to the 3D viewing construct engine. The surround information may be considered as a real-time trigger for user intent estimation/update. For example, the presence of the user at a certain location may become a trigger of estimating a user intent to read certain content related to the location. The surround information may be collected and sent to the 3D viewing construct engine along with the user input for user intent estimation.

Once the 3D viewing construct generated or updated by the 3D viewing construct engine is received through the communication interface 810, the user interface rendering module 802 starts to render the 3D viewing construct in the user viewing interface 806 in accordance with the parameters related to the configuration of the user viewing interface 806. The configuration parameters may be provided by the default configuration 814 or obtained from the meta data of the 3D viewing construct. The configuration parameters may be updated in response to the navigation information from the user interaction with the user interface rendering module 802 or from the meta data of the updated 3D viewing construct received through the communication interface 810.

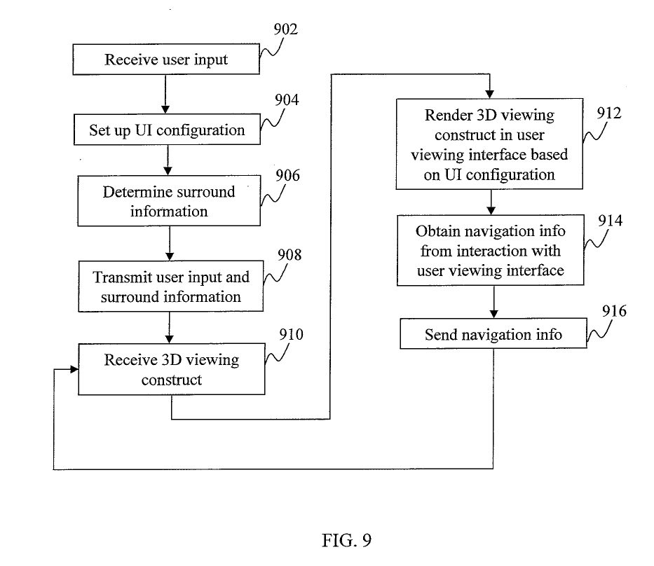

FIG. 9 is a flowchart of an exemplary process for rendering a 3D viewing construct in a user viewing interface, according to an embodiment of the present teaching. Starting from 902, user input is received, for example, through a user interface on a user device. Configuration of the user interface may be set up based on the user input at 904. A default configuration may be created and updated based on the user input. At 906, surround information, which may serve as a real-time trigger of user intent estimation/update, is determined. Moving to 908, the user input and surround information are transmitted to the 3D viewing construct engine on a remote server. At 910, a 3D viewing construct is received from the 3D viewing construct engine. The 3D viewing construct is generated based on multiple pieces of content retrieved in accordance with an estimated intent determined with respect to the user. Configuration parameters of the user viewing interface in which the 3D viewing construct is to be rendered may be also obtained either from the default configuration or from the meta data associated with the 3D viewing construct. At 912, the 3D viewing construct is rendered in the user viewing interface in accordance with the configuration parameters. Navigation information from the interaction between the user and the user viewing interface is obtained at 914. The user interaction includes, for example, cursor hovering, zooming, clicking, sliding, scrolling, taping, and pressing. At block 916, the navigation information is sent to 3D viewing construct engine, for example, on the remote server. The process may then loop back to 910, where an updated 3D viewing construct is received. The updated 3D viewing construct is generated based on the navigation information with respect to the 3D viewing construct. That is, the 3D viewing construct is dynamically updated based on updated user intent estimated by analyzing the continuously monitored navigation information.

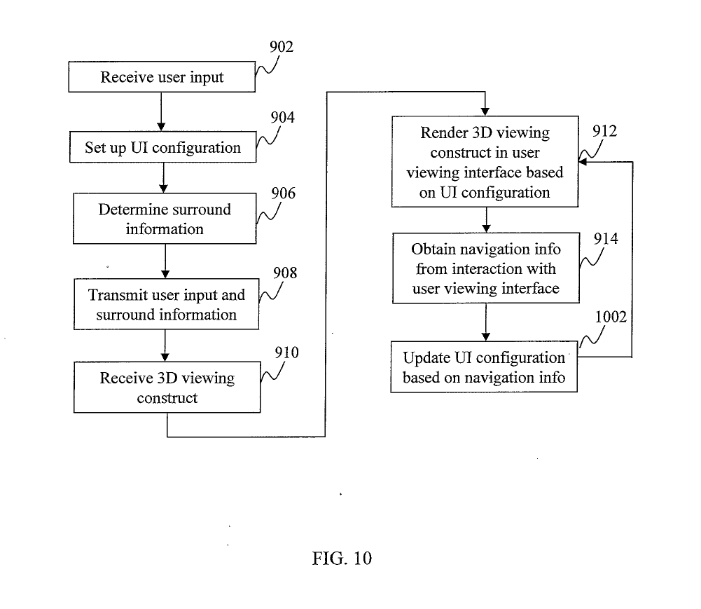

FIG. 10 presents a similarly process as what is shown in FIG. 10 except that at 1002, one or more configuration parameters of the user viewing interface are updated based on the navigation information, which causes the 3D viewing construct to be re-rendered in the user viewing interface, at 912, based on the updated configuration parameters. The navigation information obtained in FIG. 10 is not sent back to the 3D viewing construct engine to update the 3D viewing construct as shown in FIG. 9. Instead, the navigation information obtained in FIG. 10 merely causes the changes of the configuration of the user viewing interface in which the same 3D viewing construct is re-rendered. That is, the content presented to the user does not change in this example, and only the configuration of the user viewing interface, i.e., the way in which the content is presented, is changed. For example, the user may merely resize the main content display panel without interacting with any specific content. Thus, the content needs not to be updated, and only the configuration of the user viewing interface is changed. The user in this example may continuously change the configuration of the user viewing interface without updating the 3D viewing construct to achieve the desirable visual effect.

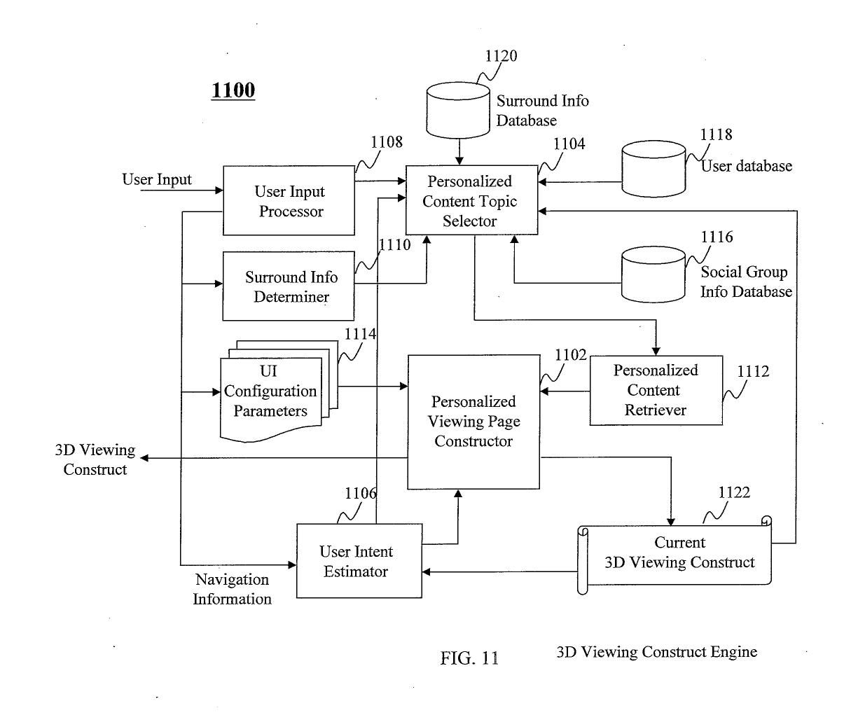

FIG. 11 is an exemplary functional block diagram of 3D viewing construct engine for generating a 3D viewing construct, according to an embodiment of the present teaching. The 3D viewing construct engine 1100 includes a personalized viewing page constructor 1102, a personalized content topic selector 1104, a user intent estimator 1106, a user input processor 1108, a surround information determiner 1110, and a personalized content retriever 1112. Databases, such as a social group information database 1116, a user database 1118, and a surround information database 1120 may be also parts of the 3D viewing construct engine 1100 or attached to it. The 3D viewing construct engine 11.00 is configured to retrieve personalized content based on an estimated intent of the user and generate a 3D viewing construct based on the retrieved personalized content for the user. The 3D viewing construct engine 1100 may further dynamically update the 3D viewing construct based on navigation information received from the interaction between the user and the user viewing interface in which the 3D viewing construct is rendered.

In this example, the user input processor 1108 is responsible for receiving user input from the user device and dispatch different types of user input to other components. For example, part of the user input, such as demographics or user profile, may go directly to the personalized content topic selector 1104 as a basis for inferring user intent. Surround information, such as the current location of the user or the time of day, is extracted and sent to the surround information determiner 1110 and eventually used by the personalized content topic selector 1104 for estimating user intents. Configuration parameters 1114 of the user viewing interface may be also extracted from the user input by the user input processor 1108 and sent to the personalized viewing page constructor 1102 for creating 3D viewing constructs. Navigation information from the user input may be dispatched to the user intent estimator 1106 for dynamically updating user intents based on user interactions with the user viewing interface,

The personalized content topic selector 1104 may estimate the user intent based on, for example, use profile, demographics, surround information, and any other information related to the user. Additionally or optionally, the user intent may be estimated and updated by the user intent estimator 1106 and provided to the personalized content topic selector 1104. The social group information database 1116, user database 1118, and surround information database 1120 may be used by the personalized content topic selector 1104 for obtaining more user-related information in estimating the user intent. In this example, the personalized content retriever 1112 then retrieves different pieces of content based on estimated user intent from various content sources. In other words, the personalized content topic selector 1104 in conjunction with the personalized content retriever 1112 are response for collecting personalized content for the user.

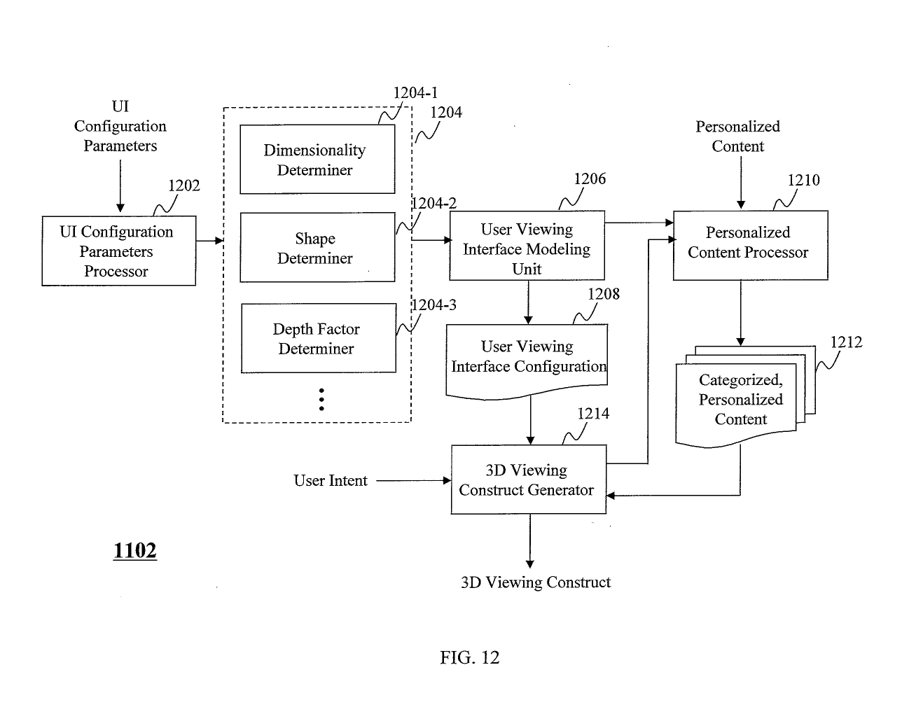

Based on the retrieved personalized content and configuration parameters 1114, the personalized viewing page constructor 1102 is configured to generate a current 3D viewing construct 1122 to be rendered in a user viewing interface. In addition, based on the update intent derived from the navigation information, the personalized viewing page constructor 1102 is further configured to dynamically update the current 3D viewing construct 1122. Referring now to FIG. 12, where an exemplary functional block diagram of the personalized viewing page constructor 1102 is presented, according to an embodiment of the present teaching. The personalized viewing page constructor 1102 in this example includes a user interface configuration parameters processor 1202, multiple configuration parameter determiners 1204, a user viewing interface modeling unit 1206, a personalized content processor 1210, and a 3D viewing construct generator 1214.

The user interface configuration parameters processor 1202 may dispatch different configuration parameters to the corresponding configuration parameter determiners 1204, such as a dimensionality determiner 1204-1, a shape determine 1204-2, a depth factor determiner 1204-3, etc., in order to determine a specific value for each parameter. The values of the configuration parameters may be used by the user viewing interface modeling unit 1206 to set up the user viewing interface configuration 1208. On the other hand, the personalized content processor 1210 may process the retrieved personalized content, for example, by organizing them into different categories. In one example, the categories may be determined based on the types of content to be displayed on each supplemental content display panel of the user viewing interface. Thus, the configuration parameters may affect the process of categorizing the personalized content. For example, the personalized content may be categorized into contextual content, advertisement, and social network information. It is understood that, the granularity of the categorization may be adjusted, and more specific categories may be applied by the personalized content processor 1210 to break down the retrieved personalized content into specific groups, each of which is directed to a concept/topic.

The 3D viewing construct generator 1214 then takes both the user viewing interface configuration 1208 and the categorized personalized content 1212 and generates the 3D viewing construct. As mentioned above, the 3D viewing construct may be a data structure with a collection of content and/or links to content associated with meta data indicating which piece of content is designated to be displayed in which region of a user viewing interface. The meta data may include parameters related to the configuration of the user viewing interface. In this example, updated user intent may be fed back to the 3D viewing construct generator 1214 to dynamically update the 3D viewing construct in response to user interaction with the current 3D viewing construct. In building the 3D viewing construct, the 3D viewing construct generator 1214 selects, with respect to the main content display panel in the user viewing interface, the main content from the categorized personalized content based on the estimated user intent. For example, if the user intent is estimated to be searching for the most popular movie, then the latest news about the 007 Sky Fall movie may be selected as the main content to be displayed on the main content display panel. The 3D viewing construct generator 1214 may also determine, with respect to each supplemental content display panel in the user viewing interface, the supplemental content to be displayed thereon based on a respective relationship of the supplemental content with the main content. For example, contextual content, such as the IMDB page of the 007 Sky Fall movie, advertisements related to ticket sales of the 007 Sky Fall movie, and social network information, such as social groups of 007 fans, may be determined as they are related to the main content. The 3D viewing construct is then generated by the 3D viewing construct generator 1214 by arranging each piece of selected content to the corresponding content display panel in accordance with the user viewing interface configuration 1208.

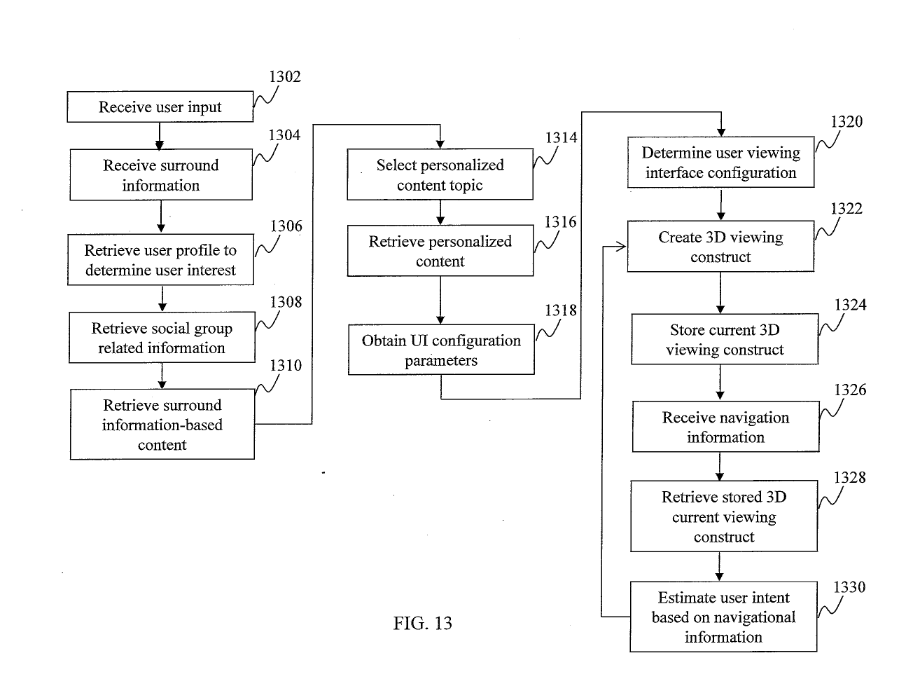

FIG. 13 is a flowchart of an exemplary process for generating a 3D viewing construct, according to an embodiment of the present teaching. Stating from 1302, user input is received, for example, from a user device. At 1304, surround information, such as the user's current location, is also received, for example, from the user device. Based on user profile from the user input, user interests are determined. The user interests may be declared interests or inferred interests. At 1308, social group related information is also retrieved to select personalized content topic/intent. At 1310, surround information-based content is retrieved as well based on the received surround information. For example, content related to a specific location may be retrieved at this step once the presence of the user in the location is detected. Moving to 1314, personalized content topic/user browsing intent is determined based on user input and additional information retrieved at 1306, 1308, 1310. Personalized content is retrieved, at 1316, based on the estimated personalized content topic/user browsing intent. At 1318, configuration parameters of the user viewing interface are extracted from the user input and obtained. Moving to 1320, the configuration of the user viewing interface is determined based on the obtained configuration parameters. A 3D viewing construct is then created based on the retrieved personalized content and the configuration of the user viewing interface at 1322. The current 3D viewing construct is stored at 1324 and transmitted to the user device for rendering. At 1326, navigation information that indicates an update of the user intent may be received. The stored current 3D viewing construct is then retrieved at 1328. Moving to 1330, updated user intent is estimated based on the navigation information. The process then may loop back to 1322, where an updated 3D viewing construct is generated based on the navigation information with respect to the stored current 3D viewing construct. That is, the 3D viewing construct is dynamically updated based on the updated user intent estimated by analyzing the continuously monitored navigation information.

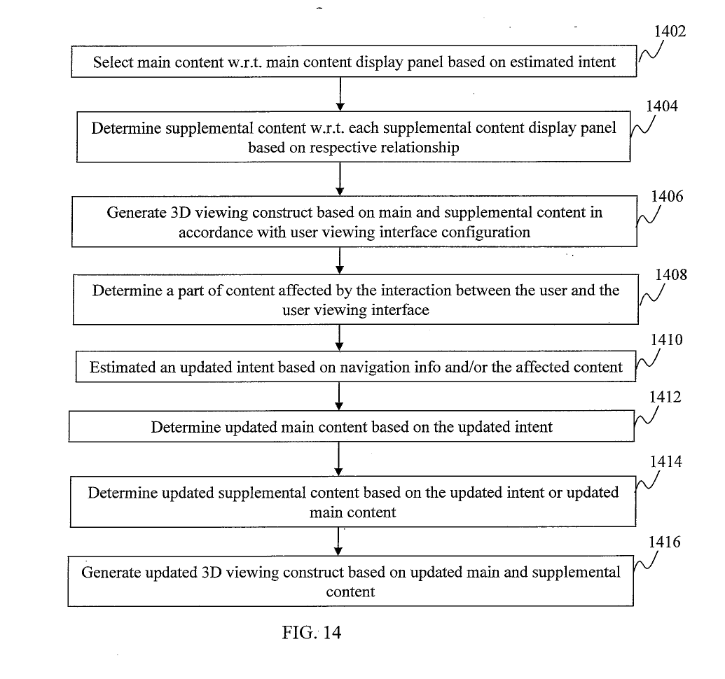

FIG. 14 is a flowchart of another exemplary process for generating a 3D viewing construct, according to an embodiment of the present teaching. Starting from 1402, the main content, with respect to the main content display panel, is selected from the plurality pieces of content based on the estimated intent. For example, the main content may be the most relevant and/or the most popular content among all the retrieved content with respect to the user intent. At 1404, the supplemental content to be displayed on each supplemental content display panel is determined based on a respective relationship of the supplemental content with the main content. As mentioned above, assuming a specific type of supplemental content has been set up by the user or by default for each supplemental content display panel, then for each supplemental content display panel, the supplemental content may be determined as the most relevant content among all the specific type of content with respect to the main content and/or the user intent. For example, one of the supplemental content display panels is set up by a configuration parameter to display social group related information, and the main content displayed on the main content display panel is the latest news of the 007 Sky Fall movie. In one example, the supplemental content may be the most popular social group discussing the movie, which is related to the estimated user intent of searching for the most popular movie, but is not directly related to the news itself In another example, if a comment about the movie made by a critic shows up in the news, then the supplemental content may be a social group including that critic, which is chosen because of its strong relationship with the main content. Moving to 1406, a 3D viewing construct is generated based on the selected main content and each piece of supplemental content in accordance with the user viewing interface configuration.

At 1408, an interaction between the user and the user viewing interface may affect a part of the content in the 3D viewing construct. For example, the user may click the link to the cast of the movie in one of the supplemental content display panels, or the user may zoom in a portion of the movie news that talks about Daniel Craig. The affected content and/or the navigation information from the user interaction, e.g., clicking a link, zooming in part of the news, are analyzed for estimating an updated intent behind the user interaction. In one example, clicking a link clearly suggests the user's intent to explore the content to which the link directs. That is, the user may be more interested in learning more about the cast of the movie than the news. In another example, content analysis may be performed to the affected content, such as detecting terms, keywords, topics, and entities associated with the affected content. For example, the actor Daniel Craig may be picked up from the content that is zoomed in by the user and used as a basis for estimating an update user intent to explore more about Daniel Craig. After the updated intent is estimated at 1410, update main content is determined at 1412 based on the updated intent. For example, if the update user intent is exploring more about Daniel Craig, the main content may be updated to Daniel Craig's recent Oscar interview. At 1414, updated supplemental content is determined based on the updated intent and/or based on the updated main content. In one example, if one piece of the supplemental content is contextual content and is updated based on the updated main content, then it may be updated to the winning list of Oscar this year. In another example, if the contextual content is updated based on the update user intent, e.g., exploring more about Daniel Craig, then it may be updated to Daniel Craig's profile page on IMDB. At 1416, an updated 3D viewing construct is generated based on the updated main content and supplemental content to reflect the update user intent detected based on user interactions. It is understood that in addition to the update of content, the configuration of the user viewing interface may or may not be changed because of user interactions. In one example, clicking the link to the movie cast may not cause any change to the user viewing interface. In another example, zooming in part of the main content may also increase the size of the main content display panel to display the updated main content.

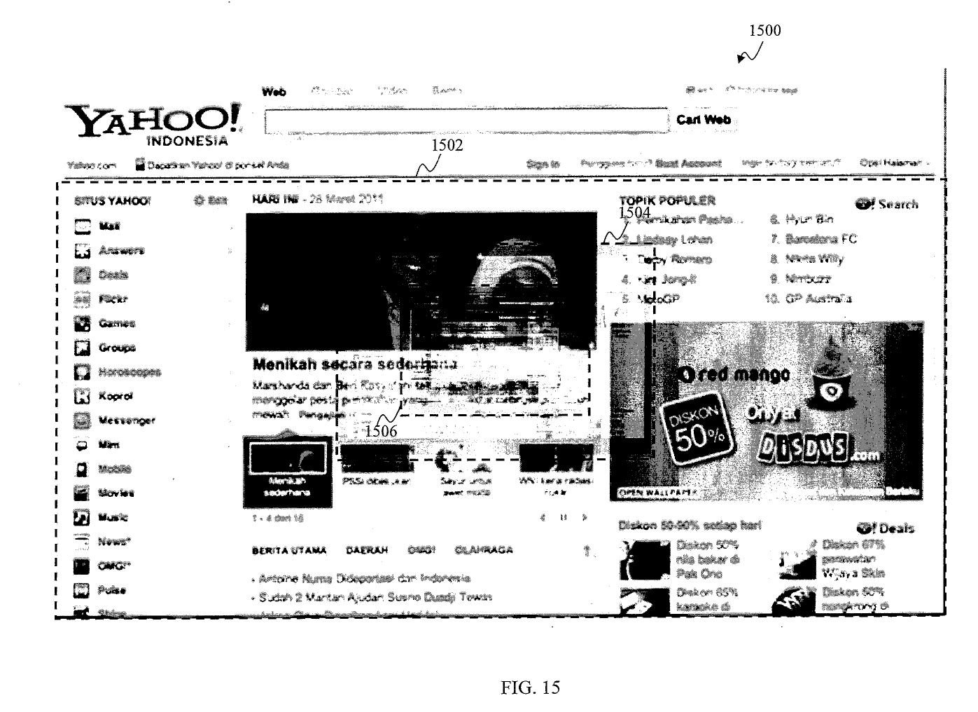

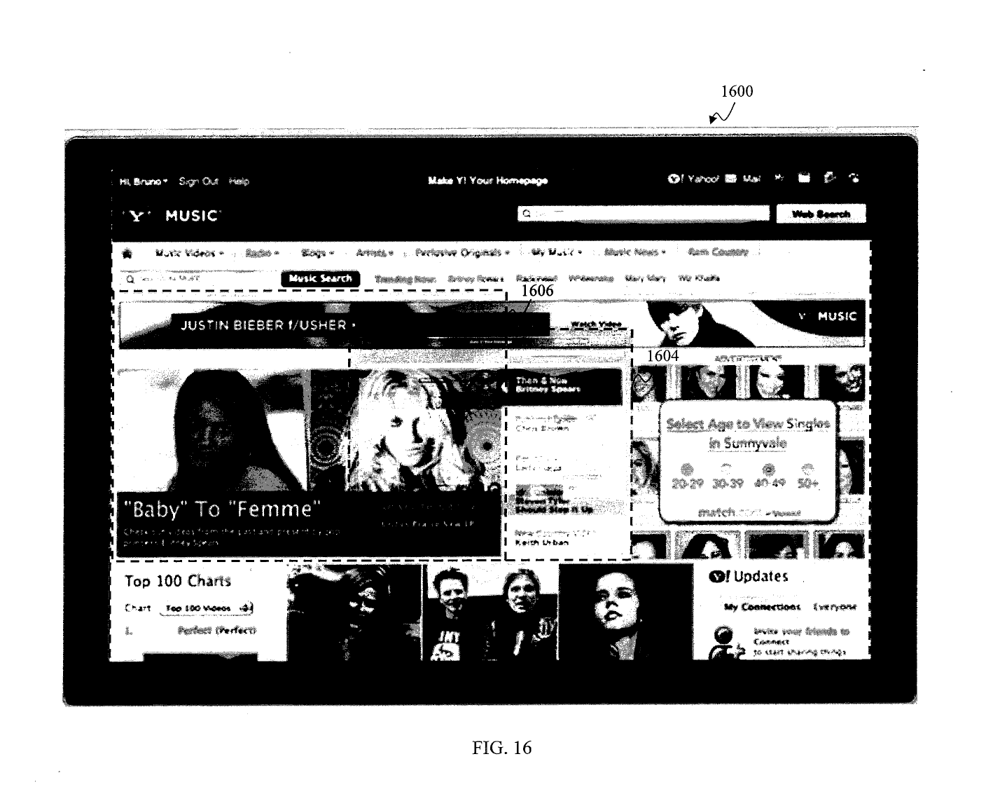

FIGS. 15-16 depict examples of rendering a 3D viewing construct in a superimposing structure on a user device, according to an embodiment of the present teaching. In FIG. 15, the user viewing interface 1500 is configured as a superimposing structure, which includes at least one main content display panel 1502 and two superimposed supplemental content display panels 1504, 1506 over the main content display panel 1502. In FIG. 16, the user viewing interface 1600 is also configured as a superimposing structure, which includes at least one main content display panel 1602 and one superimposed supplemental content display panel 1604 over the main content display panel 1602. In FIG. 16, the main content displayed on the main content display panel 1602 is Yahoo!'s personal music homepage. If the user tries to zoom in part of the main content, content analysis may be performed on the affected content 1606 and identify that the user's intent may be learning more about Britney Spears. Thus, supplemental content about Britney Spears is updated in the 3D viewing construct and rendered on the superimposed supplemental content display panel 1604 as shown in FIG. 16.

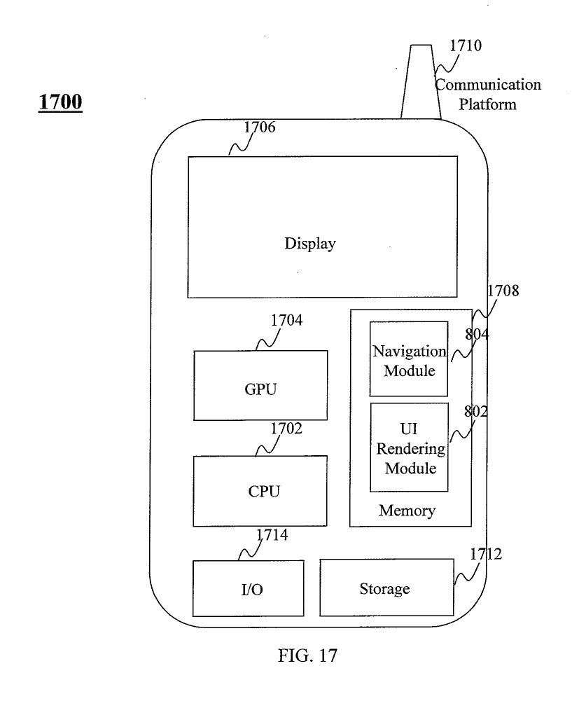

FIG. 17 depicts an exemplary functional block diagram of a user device on which the navigation module and user interface rendering module reside, according to an embodiment of the present teaching. In this example, the user device is a mobile device 1700, including but is not limited to, a smart phone, tablet, music player, handled gaming console, GPS. The mobile device 1700 in this example includes one or more central processing units (CPUs) 1702, one or more graphic processing units (GPUs) 1704, a display 1706, a memory 1708, a communication platform 1710, such as a wireless communication module, a storage 1712, and one or more input/output (I/O) devices 1714. Any other suitable component, such as but not limited to a system bus or a controller (not shown), may also be included in the mobile device 1700. As shown in FIG. 17, the navigation module 804 and user interface rendering module 802 may be loaded into the memory 1708 from the storage 1712 in order to be executed by the CPU 1702. Execution of the navigation module 804 and user interface rendering module 802 may cause the mobile device 1700 to perform the processing as described above, e.g., in FIGS. 9, 10. For example, the 3D viewing construct may be rendered and presented in the user viewing interface by the GPU 1704 in conjunction with the display 1706. The interaction between the user and the user viewing interface may be performed through the I/O devices 1714. The user input, 3D viewing construct, and navigation information may be communicated between the mobile device 1700 and the remote 3D viewing construct engine through the communication platform 1710.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

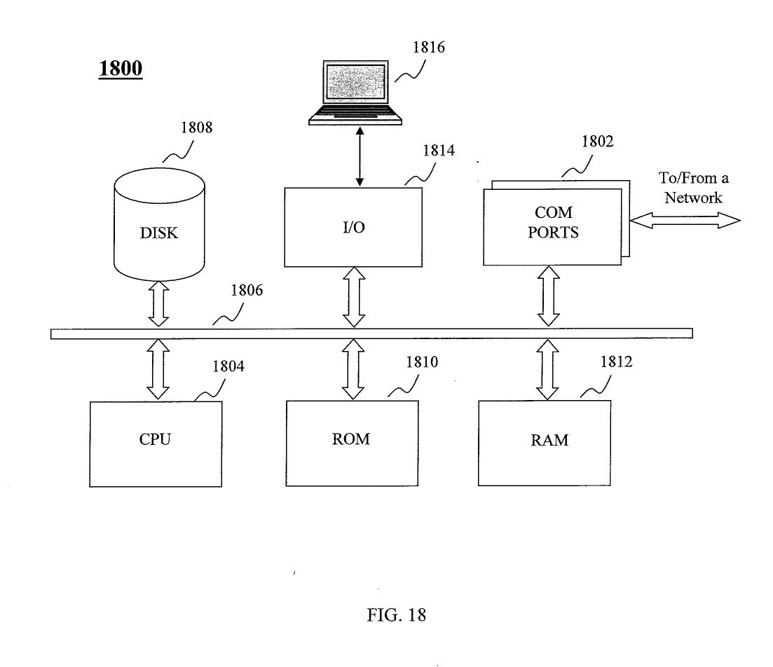

FIG. 18 depicts a general computer architecture on which the present teaching can be implemented and has a functional block diagram illustration of a computer hardware platform that includes user interface elements. The computer may be a general-purpose computer or a special purpose computer. This computer 1800 can be used to implement any components of the 3D viewing construct generation and rendering architecture as described herein. Different components of the system as depicted in the figures can all be implemented on one or more computers such as computer 1800, via its hardware, software program, firmware, or a combination thereof. Although only one such computer is shown, for convenience, the computer functions relating to content search may be implemented in a distributed fashion on a number of similar platforms, to distribute the processing load.

The computer 1800, for example, includes COM ports 1802 connected to and from a network connected thereto to facilitate data communications. The computer 1800 also includes a central processing unit (CPU) 1804, in the form of one or more processors, for executing program instructions. The exemplary computer platform includes an internal communication bus 1806, program storage and data storage of different forms, e.g., disk 1808, read only memory (ROM) 1810, or random access memory (RAM) 1812, for various data files to be processed and/or communicated by the computer, as well as possibly program instructions to be executed by the CPU 1804. The computer 1800 also includes an I/O component 1814, supporting input/output flows between the computer and other components therein such as user interface elements 1816. The computer 1800 may also receive programming and data via network communications.

Hence, aspects of the method for generating and rendering a viewing constant, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the computer-implemented method.

All or portions of the computer-implemented method may at times be communicated through a network such as the Internet or various other telecommunication networks. Such communications, for example, may enable loading of the computer-implemented method from one computer or processor into another. Thus, another type of media that may bear the computer-implemented method elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the computer-implemented method. As used herein, unless restricted to tangible “storage” media, terms such as computer or machine “readable medium” refer to any medium that participates in providing instructions to a processor for execution,

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine, each of which has at least one processor, storage, and a communication platform connected to a network for providing content, the method comprising:
retrieving a plurality pieces of content in accordance with an estimated intent determined with respect to a user;
generating a three-dimensional (3D) viewing construct based on the plurality pieces of content, where the 3D viewing construct is to be rendered in a user viewing interface comprising a plurality of content display panels, wherein each of the plurality of content display panels is used to display at least one of the plurality pieces of content;
receiving navigation information from an interaction between the user and the user viewing interface; and
dynamically updating the 3D viewing construct based on the navigation information,

2. The method of claim 1, wherein the plurality of content display panels include a main content display panel for displaying main content selected from the plurality pieces of content based on the estimated intent of the user and one or more supplemental content display panels used to display supplemental pieces of content related to the main content.

3. The method of claim 1, wherein the 3D viewing construct is generated based on one or more parameters related to a configuration of the user viewing interface.

4. The method of claim 3, wherein the configuration of the user viewing interface is one of a default configuration and a user configuration specified by the user, where the one or more parameters are generated based on the configuration, including at least one of:
a dimensionality of the user viewing interface;
a shape of the user viewing interface;
a shape and/or a size of the main content display panel;
a depth factor of the user viewing interface;
construction parameters indicating relative spatial relationships of the plurality of content display panels of the user viewing interface;
a number of supplemental content display panels and/or a shape and size of each of the supplemental content display panels;
a relative position of the main content display panel;
a relative position of each of the one or more supplemental content display panels;
a layout of the main content display panel;
a layout of each of the one or more supplemental content display panels;
an aspect ratio of the main content display panel; and
an aspect ratio of each of the one or more supplemental content display panels.

5. The method of claim 2, wherein the step of generating a 3D viewing construct comprises:
selecting, with respect to the main content display panel, the main content from the plurality pieces of content based on the estimated intent;
determining, with respect to each supplemental content display panel, the supplemental content to be displayed thereon based on a respective relationship of the supplemental content with the main content; and
generating the 3D viewing construct based on the main content and supplemental content in accordance with the configuration of the user viewing interface.

6. The method of claim 5, wherein the supplemental content includes at least one of contextual content, advertisement, and social network information associated with the main content and/or information related to the user.

7. The method of claim 1, wherein the interaction between the user and the user viewing interface includes at least one of cursor hovering, zooming, clicking, sliding, scrolling, taping, and pressing.

8. The method of claim 7, wherein the navigation information from the interaction points to a part of content displayed in the user viewing interface that is affected by the interaction between the user and the user viewing interface.

9. The method of claim 8, wherein the step of dynamically updating the 3D viewing construct comprises:
determining the part of content affected by the interaction; and
estimating an updated intent of the user based on the navigation information and/or the part of content affected by the interaction.

10. The method of claim 9, wherein the step of dynamically updating the 3D viewing construct further comprises:
determining updated main content to be displayed on the main content display panel based on the updated intent;
determining updated supplemental content to be displayed on each of the one or more supplemental content display panels based on the updated main content and/or the updated intent; and
generating an updated 3D viewing construct based on the updated main content and updated supplemental content.

11. The method of claim 3, wherein the user viewing interface is configured as a 3D pipe structure comprising a cross section and a plurality of side walls.

12. The method of claim 11, wherein a shape of the cross section includes at least one of a circle, an ellipse, a square, and a rectangular.

13. The method of claim 11, wherein each of the plurality of side walls includes a flat surface or a curved surface.

14. The method of claim 3, wherein the user viewing interface is configured as a superimposing structure, where at least one of the supplemental content display panels is superimposed on at least one of the main content display panel and/or a different supplemental content display panel.

15. The method of claim 14, wherein the supplemental content displayed on a superimposed supplemental content display panel is determined based on an updated intent of the user estimated in accordance with the navigation information.

16. A method implemented on at least one machine, each of which has at least one processor, storage, and a communication platform connected to a network for providing content, the method comprising:
receiving a 3D viewing construct comprising a plurality pieces of content retrieved in accordance with an estimated intent with respect to a user;
obtaining one or more parameters related to a configuration of a user viewing interface;
rendering the 3D viewing construct in the user viewing interface in accordance with the one or more parameters related to the configuration of the user viewing interface;
obtaining navigation information based on an interaction between the user and the user viewing interface;
transmitting the navigation information; and
receiving an updated 3D viewing construct, wherein the updated 3D viewing construct is generated based on the navigation information with respect to the 3D viewing construct.

17. The method of claim 16, wherein the plurality of content display panels include a main content display panel for displaying main content selected from the plurality pieces of content based on the estimated intent of the user and one or more supplemental content display panels used to display supplemental pieces of content related to the main content.

18. The method of claim 17, wherein the supplemental content includes at least one of contextual content, advertisement, and social network information associated with the main content and/or information related to the user.

19. The method of claim 16, wherein the interaction between the user and the user viewing interface includes at least one of cursor hovering, zooming, clicking, sliding, scrolling, taping, and pressing.

20. The method of claim 17, wherein:
the updated 3D viewing construct is generated based on updated main content to be displayed on the main content display panel and updated supplemental content to be displayed on each of the one or more supplemental content display panels;
the updated main content is determined based on an updated intent estimated based on the navigation information; and
the updated supplemental content is determined based on the updated main content and/or the updated intent.

21. The method of claim 16, wherein the user viewing interface is rendered as a 3D pipe structure comprising a cross section and a plurality of side walls.

22. The method of claim 21, wherein a shape of the cross section includes at least one of a circle, an ellipse, a square, and a rectangular.

23. The method of claim 21, wherein each of the plurality of side walls includes a flat surface or a curved surface.

24. The method of claim 16, wherein the user viewing interface is rendered as a superimposing structure, where at least one of the supplemental content display panels is superimposed on at least one of the main content display panel and/or a different supplemental content display panel.

25. The method of claim 24, wherein the supplemental content displayed on a superimposed supplemental content display panel is determined based on an updated intent of the user estimated in accordance with the navigation information.

26. A method implemented on at least one machine, each of which has at least one processor, storage, and a communication platform connected to a network for providing content, the method comprising:
receiving a 3D viewing construct comprising a plurality pieces of content retrieved in accordance with an estimated intent with respect to a user;
obtaining one or more parameters related to a configuration of a user viewing interface;
rendering the 3D viewing construct in the user viewing interface in accordance with the one or more parameters related to the configuration of the user viewing interface;
obtaining navigation information based on an interaction between the user and the user viewing interface; and
re-rendering the 3D viewing construct in the user viewing interface based on the navigation information.

27. The method of claim 26, wherein the plurality of content display panels include a main content display panel for displaying main content selected from the plurality pieces of content based on the estimated intent of the user and one or more supplemental content display panels used to display supplemental pieces of content related to the main content.

28. The method of claim 27, wherein the supplemental content includes at least one of contextual content, advertisement, and social network information associated with the main content and/or information related to the user.

29. The method of claim 26, wherein the interaction between the user and the 3D user viewing construct includes at least one of cursor hovering, zooming, clicking, sliding, scrolling, taping, and pressing.

30. The method of claim 26, wherein the user viewing interface is rendered as a 3D pipe structure comprising a cross section and a plurality of side walls.

31. The method of claim 30, wherein a shape of the cross section includes at least one of a circle, an ellipse, a square, and a rectangular.

32. The method of claim 30, wherein each of the plurality of side walls includes a flat surface or a curved surface.

33. The method of claim 26, wherein the user viewing interface is rendered as a superimposing structure, where at least one of the supplemental content display panels is superimposed on at least one of the main content display panel and/or a different supplemental content display panel.

34. The method of claim 33, wherein the supplemental content displayed on a superimposed supplemental content display panel is determined based on an updated intent of the user estimated in accordance with the navigation information.

35. A system for providing content comprising:
a personalized content retriever configured to retrieve a plurality pieces of content in accordance with an estimated intent determined with respect to a user;
a personalized viewing pager constructor configured to generate a three-dimensional (3D) viewing construct based on the plurality pieces of content, where the 3D viewing construct is to be rendered in a user viewing interface comprising a plurality of content display panels, wherein each of the plurality of content display panels is used to display at least one of the plurality pieces of content; and
a user intent estimator configured to receive navigation information from an interaction between the user and the user viewing interface, wherein
the personalized viewing pager constructor is further configured to dynamically update the 3D viewing construct based on the navigation information.

36. A system for providing content comprising:
a communication interface configured to:
receive a 3D viewing construct comprising a plurality pieces of content retrieved in accordance with an estimated intent with respect to a user, and
obtain one or more parameters related to a configuration of a user viewing interface;
a user interface rendering module configured to render the 3D viewing construct in the user viewing interface in accordance with the one or more parameters related to the configuration of the user viewing interface; and
a navigation module configured to obtain navigation information based on an interaction between the user and the user viewing interface, wherein
the communication interface is further configured to:
transmit the navigation information, and
receive an updated 3D viewing construct, wherein the updated 3D viewing construct is generated based on the navigation information with respect to the 3D viewing construct.

37. A system for providing content comprising:
a communication interface configured to:
receive a 3D viewing construct comprising a plurality pieces of content retrieved in accordance with an estimated intent with respect to a user, and
obtain one or more parameters related to a configuration of a user viewing interface;
a user interface rendering module configured to render the 3D viewing construct in the user viewing interface in accordance with the one or more parameters related to the configuration of the user viewing interface; and
a navigation module configured to obtain navigation information based on an interaction between the user and the user viewing interface, wherein the user interface rendering module is further configured to re-render the 3D viewing construct in the user viewing interface based on the navigation information.

38. A machine-readable tangible and non-transitory medium having information recorded thereon for providing content, wherein the information, when read by the machine, causes the machine to perform the following:
retrieving a plurality pieces of content in accordance with an estimated intent determined with respect to a user;
generating a three-dimensional (3D) viewing construct based on the plurality pieces of content, where the 3D viewing construct is to be rendered in a user viewing interface comprising a plurality of content display panels, wherein each of the plurality of content display panels is used to display at least one of the plurality pieces of content;
receiving navigation information from an interaction between the user and the user viewing interface; and
dynamically updating the 3D viewing construct based on the navigation information.

39. A machine-readable tangible and non-transitory medium having information recorded thereon for providing content, wherein the information, when read by the machine, causes the machine to perform the following:
receiving a 3D viewing construct comprising a plurality pieces of content retrieved in accordance with an estimated intent with respect to a user;
obtaining one or more parameters related to a configuration of a user viewing interface;
rendering the 3D viewing construct in the user viewing interface in accordance with the one or more parameters related to the configuration of the user viewing interface;
obtaining navigation information based on an interaction between the user and the user viewing interface;
transmitting the navigation information; and
receiving an updated 3D viewing construct, wherein the updated 3D viewing construct is generated based on the navigation information with respect to the 3D viewing construct.

40. A machine-readable tangible and non-transitory medium having information recorded thereon for providing content, wherein the information, when read by the machine, causes the machine to perform the following:
receiving a 3D viewing construct comprising a plurality pieces of content retrieved in accordance with an estimated intent with respect to a user;
obtaining one or more parameters related to a configuration of a user viewing interface;
rendering the 3D viewing construct in the user viewing interface in accordance with the one or more parameters related to the configuration of the user viewing interface;
obtaining navigation information based on an interaction between the user and the user viewing interface; and
re-rendering the 3D viewing construct in the user viewing interface based on the navigation information.
